(19) United States
(12) Patent Application Publication
(10) Pub. No.: US 2014/0046837 A1
(43) Pub. Date: Feb. 13, 2014

(54) SYSTEMS AND METHODS FOR FACILITATING ELECTRONIC PAYMENT SERVICE PROVIDER TRANSACTIONS USING PHYSICAL OBJECTS

(71) Applicant: Max Edward Metral, Brookline, MA (US)

(72) Inventor: Max Edward Metral, Brookline, MA (US)

(73) Assignee: eBay, Inc., San Jose, CA (US)

(21) Appl. No.: 13/571,006

(22) Filed: Aug. 9, 2012

(51) Int. Cl. G06Q 40/02

(52) U.S. Cl. 705/41; 705/42

(57) ABSTRACT

A device for processing a transaction between a sender and a recipient using a physical object is provided. The device includes a network interface component coupled to a network that receives data packets including first image data and an amount to be associated with the first image data. The device also includes a memory coupled to the network interface component storing the first image data and the amount, and one or more processors coupled to the memory and the network interface component. The one or more processors match second image data included in a second one or more data packets received by the network interface component from the recipient to the first image data, determine the amount associated with the first image data if the second image data matches the first image data, and transfer the associated amount from a sender account to a recipient account.

### BACKGROUND

1. Technical Field

Embodiments disclosed herein are related to devices, systems, and methods for facilitating payment service provider transactions using physical objects. In particular, devices, systems, and methods disclosed herein may be used to create a payment service provider-redeemable gift card using a physical object.

2. Related Art

Computing devices have become routine appliances in the homes of most families. Mobile computing devices, such as mobile phones, smartphones, and tablet computers have become as much a part of a person's daily accessories as a wallet or purse. The integration of computing devices into our daily lives has led to people living a more digital lifestyle, where many actions that were once conducted personally are now conducted electronically. For example, consumers are increasingly buying and selling items electronically. People are communicating to one another using e-mail, instant messaging, or social networking services. Banking, bill paying, and other financial transactions are carried out online instead of at the bank.

While this digital lifestyle offers convenience for its adopters, communications and interactions have become increasingly impersonal. Even the time-honored tradition of gift giving has been replaced by electronic gift and card giving. Instead of mailing or presenting loved ones with a physical card for a special occasion, people are simply e-mailing or otherwise electronically sending a digital card, or, in some case, simply sending an e-mail. Although the receipt of a digital gift or card may be more convenient for both the sender and the recipient, it lacks the personal connection and instant gratification that can be associated with a gift exchange. Further, it fails to replicate the excitement and joy that a recipient may feel when receiving a personal gift or card.

Consequently, there is a need to try and combine the convenience of digital transactions with the personalization of receiving gifts and cards. In particular, there is a need for systems, methods, and devices for facilitating electronic payment service provider transactions using personalized physical objects.

### BRIEF DESCRIPTION OF THE FIGURES

FIG. 1 is a block diagram of a networked system, consistent with some embodiments.

FIG. 2 is a diagram illustrating a computing system, consistent with some embodiments.

FIGS. 3A-3D are diagrams illustrating the creation and redemption of a payment service provider-redeemable gift card using a physical object, consistent with some embodiments.

FIGS. 4A and 4B are flowcharts illustrating methods for the creation and redemption of a payment service provider-redeemable gift card using a physical object on a computing device, consistent with some embodiments.

FIGS. 5A and 5B are flowcharts illustrating methods for the creation and redemption of a payment service provider-redeemable gift card using a physical object on a payment service provider server, consistent with some embodiments.

In the drawings, elements having the same designation have the same or similar functions.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

Consistent with some embodiments, there is provided a device for processing a transaction between a sender and a recipient using a physical object. The device includes a network interface component coupled to a network and configured to receive a first one or more data packets that include first captured image data and an amount to be associated with the first captured image data from the sender. The device also includes a memory coupled to the network interface component and configured to store the first captured image data and the amount, and one or more processors coupled to the memory and the network interface component. The one or more processors may be configured to match second captured image data included in a second one or more data packets received by the network interface component from the recipient to the first captured image data, determine the amount associated with the first captured image data if the second captured image data matches the first captured image data, and transfer the associated amount from an account specified by the sender to an account specified by the recipient.

Consistent with some embodiments, there is also provided a method for processing a transaction between a sender and a recipient using a physical object. The method includes receiving, by a network interface component of a processing device, a first captured image of the physical object and an amount to be associated with the physical object, storing, in a memory of the processing device, the first captured image and the amount, and receiving, by the network interface component, a second captured image of the physical object. The method also includes matching, using one or more processors of the processing device, the second captured image to the first captured image, determining, by the one or more processors, the amount associated with the first captured image if the second captured image matches the first captured image, and transferring, by the one or more processors, the associated amount from an account specified by the sender to an account specified by the recipient.

Consistent with some embodiments, there is further provided a non-transitory computer-readable medium having instructions for execution by one or more processors that, when executed, cause the one or more processors to perform a method for generating and redeeming a payment service provider-redeemable gift card based on a physical object. The method includes capturing a first image of the physical object, associating an amount and recipient information with the first image, and transmitting the first image, the associated amount, and recipient information to a payment service provider server. The method also includes capturing a second image of the physical object, transmitting the second image and the recipient information to the payment service provider server, and receiving an acknowledgment message indicating that the gift card has been redeemed.

These and other embodiments will be described in further detail below with respect to the following figures.

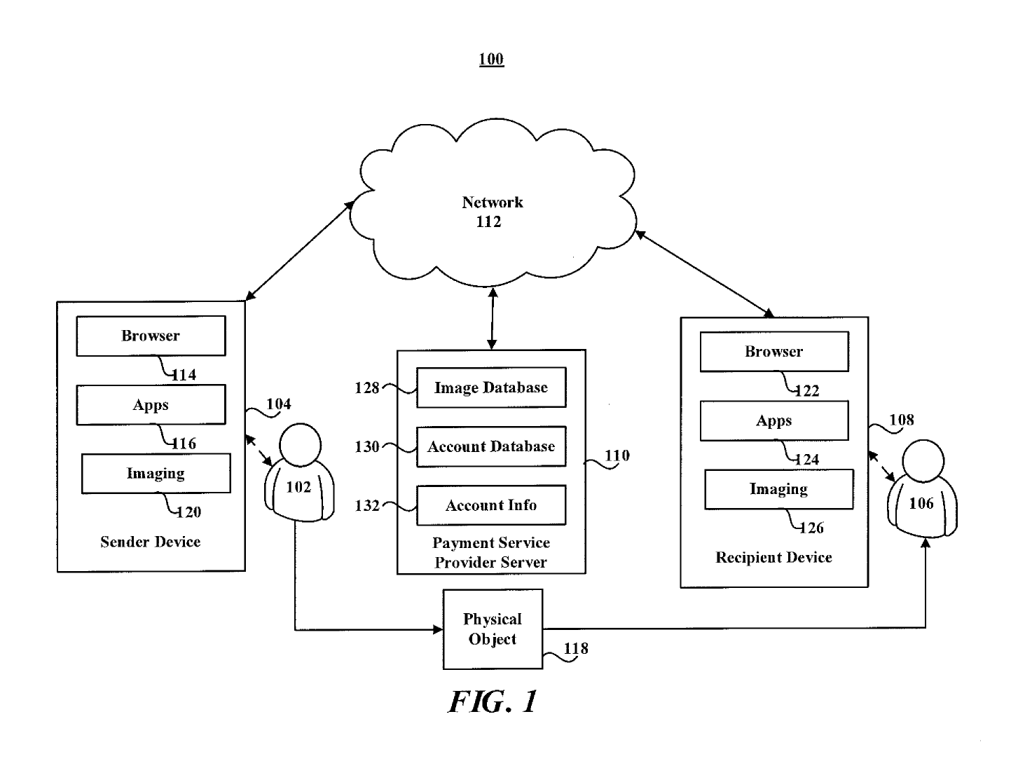

FIG. 1 is a block diagram of a networked system 100, consistent with some embodiments. System 100 includes a sender 102 having a sender device 104, a recipient 106 having a recipient device 108, and a payment service provider server 110 coupled to a network 112. Sender device 104, in one embodiment, may be implemented using any appropriate combination of hardware and/or software configured for wired and/or wireless communication over network 112. For example, sender device 104 may be implemented as a wireless telephone (e.g., smartphone), tablet, personal digital assistant (PDA), notebook computer, and/or various other generally known types of wired and/or wireless mobile computing devices. Consistent with some embodiments, sender device 104 may include any appropriate combination of hardware and/or software having one or more processors and capable of reading instructions stored on a non-transitory machine-readable medium for execution by the one or more processors. Consistent with some embodiments, sender device 104 includes a machine-readable medium, such as a memory (not shown) that includes instructions for execution by one or more processors (not shown) for causing sender device 104 to perform specific tasks. For example, such instructions may include displaying content, such as a web page or a user interface using a browser 114. Further, content may be content displayed by particular applications or “apps” 116 stored in a memory of sender device 104 and executed by one or more processors executing in sender device 104. Some common forms of machine-readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which one or more processors or computer is adapted to read.

As discussed above, sender device 104 may be a mobile device such as a smartphone such as an iPhone™ or other mobile device running the iOS™ operating system, the Android™ operating system, a BlackBerry™ operating system, the Microsoft® Windows® Phone operating system, Symbian™ OS, or webOS™. Sender device 104 may also be a tablet computer, such as an iPad™ or other tablet computer running one of the aforementioned operating systems. It should be appreciated that, in various embodiments, sender device 104 may be referred to as a user device or a customer/client device without departing from the scope of the present disclosure.

Consistent with some embodiments, browser 114 may be a mobile browser app, which may be used to provide a user interface to permit sender 102 to browse information available over network 112. For example, browser application 114 may be implemented as a web browser to view information available over network 112. Browser application 114 may include a software program, such as a graphical user interface (GUI), executable by one or more processors that is configured to interface and communicate with a payment service provider server 110 or other servers managed by content providers or merchants via network 112. For example, sender 102 is able to access websites to find and purchase items, as well as access user account information or web content. Sender 102, through sender device 104, may also communicate with payment service provider server 110 to create an account, authenticate and/or log in to the account, and make a payment to a merchant or another individual connected to network 112. According to some embodiments, sender 102 may also communicate with payment service provider server 110 to conduct a transaction using payment service provider server 110 using a physical object 118.

Applications 116 executed by one or more processors of sender device 104 may provide additional features available to sender 102, including accessing a user account with payment service provider server 110. For example, applications 116 may include interfaces and communication protocols that allow sender 102 to receive and transmit information through payment service provider server 110 and other online sites. Applications 116 may also include security applications for implementing client-side security features, programmatic client applications for interfacing with appropriate application programming interfaces (APIs) over network 112 or various other types of generally known programs and/or applications. Applications 116 may include mobile apps downloaded and resident on sender device 104 that enables sender 102 to access content through the apps.

Sender device 104 may also include imaging functionality including imaging applications 120. The imaging functionality and applications 120 may be accessed by both browser 114 and applications 116 for capturing and storing images using sender device 104. Consistent with some embodiments, browser 114 and applications 116 may leverage imaging functionality and applications 120 of sender device 104 to capture an image and format the image using appropriate APIs and protocols for transmission to payment service provider server 110. In some embodiments, imaging functionality and applications 120 of sender device may be used to capture an image of physical object 118.

Recipient device 108 may be similar to sender device 104 and include similar, if not the same functionality of sender device 104. Recipient device 108 may be implemented using any appropriate combination of hardware and/or software configured for wired and/or wireless communication over network 112. Recipient device 108 may be implemented as a wireless telephone (e.g., smartphone), tablet, personal digital assistant (PDA), notebook computer, and/or various other generally known types of wired and/or wireless mobile computing devices. Recipient device 108 may include any appropriate combination of hardware and/or software having one or more processors and capable of reading instructions stored on a non-transitory machine-readable medium for execution by the one or more processors. Consistent with some embodiments, recipient device 108 includes a machine-readable medium, such as a memory (not shown) that includes instructions for execution by one or more processors (not shown) for causing recipient device 108 to perform specific tasks. For example, such instructions may include displaying content, such as a web page or a user interface using a browser 122. Further, content may be content displayed by particular applications or “apps” 124 stored in a memory of recipient device 108 and executed by one or more processors executing in recipient device 108. Recipient device 108 may be a mobile device such as a smartphone such as an iPhone™ or other mobile device running the iOS™ operating system, the Android™ operating system, a BlackBerry™ operating system, the Microsoft® Windows® Phone operating system, Symbian™ OS, or webOS™. Recipient device 108 may also be a tablet computer, such as an iPad™ or other tablet computer running one of the aforementioned operating systems. Recipient device 108 may also include imaging functionality including imaging applications 126. Consistent with some embodiments, browser 122, applications 124, and imaging functionality and applications 126 of recipient device 108 provide similar functionality and function similarly to browser 114, applications 116 and imaging functionality and applications 120 of sender device 104.

Payment service provider server 110 may be maintained by a payment provider, such as PayPal, Inc. of San Jose, Calif. Payment service provider server 110 may be maintained by other service providers in different embodiments. Payment service provider may be more generally a web site, an online content manager, a service provider, such as a bank, or other entity who provides content to a user requiring user authentication or login. Payment service provider server 110 according to some embodiments, may be maintained by an online payment provider, which may provide processing for online financial and information transactions on behalf of a user such as sender 102 and recipient 106. Payment service provider server 110 may include an image database 128, which may be adapted to interact with sender device 104 and/or recipient device 108 over network 112 to store and match images sent by sender 102 or recipient 106 using imaging functionality and applications 120 and 126 of sender device 104 and recipient device 108. Payment service provider server 110 may be configured to maintain a plurality of user accounts in an account database 130, each of which may include or be separate from an account information 132 associated with individual users, including sender 102 and recipient 106. For example, account information 132 may include identity information of sender 102 and recipient 106, such as one or more full names, business names, street addresses, email addresses and phone numbers, website addresses, or other types of financial information, which may be used to facilitate online transactions for sender 102 and recipient 106, as well as login information. Account information 132 may also include banking accounts, credit card numbers and other relevant financial information for facilitating financial transactions entered into by at least sender 102 and recipient 106.

Network 112, in one embodiment, may be implemented as a single network or a combination of multiple networks. For example, in various embodiments, network 112 may include the Internet and/or one or more intranets, landline networks, wireless networks, and/or other appropriate types of communication networks. In another example, network 112 may comprise a wireless telecommunications network (e.g., cellular phone network) adapted to communicate with other communication networks, such as the Internet.

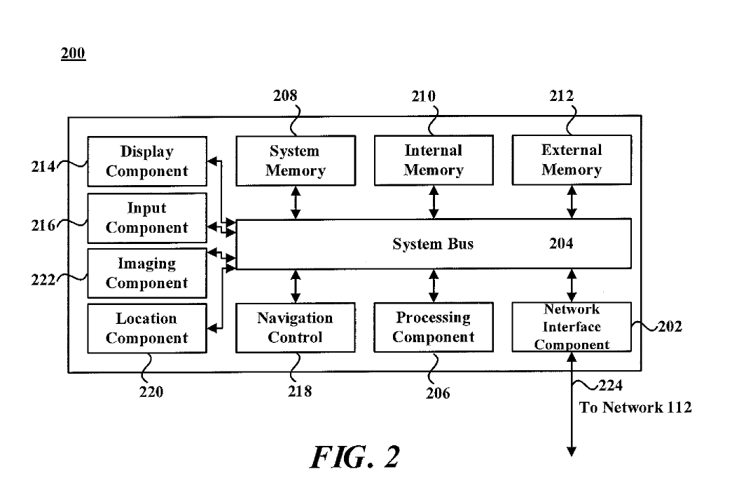

FIG. 2 is a diagram illustrating computing system 200, which may correspond to any of sender device 104, recipient device 108, or payment service provider server 110, consistent with some embodiments. Computing system 200 may be a mobile device such as a smartphone such as an iPhone™ or other mobile device running the iOS™ operating system, the Android™ operating system, a BlackBerry™ operating system, the Microsoft® Windows® Phone operating system, Symbian™ OS, or webOS™. Computing system 200 may also be a tablet computer such as the iPad™ or other similar device running the aforementioned operating systems. Computing system 200 may also be personal computer, laptop computer, netbook, or tablet computer. Further, computing system 200 may also be a server or one server amongst a plurality of servers, as would be consistent with payment service provider server 110. As shown in FIG. 2, computing system 200 includes a network interface component (NIC) 202 configured for communication with a network such as network 112 shown in FIG. 1. Consistent with some embodiments, NIC 202 includes a wireless communication component, such as a wireless broadband component, a wireless satellite component, or various other types of wireless communication components including radio frequency (RF), microwave frequency (MWF), and/or infrared (IR) components configured for communication with network 112. Consistent with other embodiments, NIC 202 may be configured to interface with a coaxial cable, a fiber optic cable, a digital subscriber line (DSL) modem, a public switched telephone network (PSTN) modem, an Ethernet device, and/or various other types of wired and/or wireless network communication devices adapted for communication with network 112.

Consistent with some embodiments, computing system 200 includes a system bus 204 for interconnecting various components within computing system 200 and communication information between the various components. Such components include a processing component 206, which may be one or more processors, micro-controllers, or digital signal processors (DSP), a system memory component 208, which may correspond to random access memory (RAM), an internal memory component 210, which may correspond to read-only memory (ROM), and a external or static memory 212, which may correspond to optical, magnetic, or solid-state memories. Consistent with some embodiments, computing system 200 further includes a display component 214 for displaying information to a user, such as sender 102 or recipient 106 of computing system 200. Display component 214 may be a liquid crystal display (LCD) screen, an organic light emitting diode (OLED) screen (including active matrix AMOLED screens), an LED screen, a plasma display, or a cathode ray tube (CRT) display. Computing system 200 may also include an input component 216, allowing for a user of computing system 200 to input information to computing system 200. Such information could include payment information such as an amount required to complete a transaction, account information, authentication information, or identification information. An input component 216 may include, for example, a keyboard or key pad, whether physical or virtual. Computing system 200 may further include a navigation control component 218, configured to allow a user to navigate along display component 214. Consistent with some embodiments, navigation control component 218 may be a mouse, a trackball, or other such device. Moreover, if device 200 includes a touch screen, display component 214, input component 216, and navigation control 218 may be a single integrated component, such as a capacitive sensor-based touch screen.

Consistent with some embodiments, computing system 200 may include a location component 220 for determining a location of computing system 220. In some embodiments, location component 220 may correspond to a GPS transceiver that is in communication with a GPS satellite. In other embodiments, location component 220 may be configured to determine a location of computing system 200 by using an internet protocol (IP) address lookup, or by triangulating a position based on nearby mobile communications towers. Location component 220 may be further configured to store a user-defined location in any of system memory 208, internal memory 210, and/or external memory 212 that can be transmitted to a third party for the purpose of identifying a location of computing system 200. Computing system 200 may also include an imaging component 222 for capturing and/or processing images. With reference to FIG. 1, imaging component 222 may be used in conjunction with imaging functionality and applications 120 and 126 of sender device 104 and recipient device 108, or with image database 128 of payment service provider server 110. Imaging component 222 may include a combination of hardware, such as lenses, sensors, and software for capturing an image. Imaging component 222 may be a camera built in to a device, such as a smartphone, tablet, or laptop computer, or may be a camera that is coupled to computing system 200 by a cable. Computing system 200 may perform specific operations by processing component 206 executing one or more sequences of instructions contained in system memory component 208, internal memory component 210, and/or external or static memory 212. In other embodiments, hard-wired circuitry may be used in place of or in combination with software instructions to implement the present disclosure.

Logic may be encoded in a computer readable medium, which may refer to any medium that participates in providing instructions to processing component 206 for execution. Such a medium may take many forms, including but not limited to, non-volatile media, volatile media, and transmission media. The medium may correspond to any of system memory 208, internal memory 210 and/or external or static memory 212. Consistent with some embodiments, the computer readable medium is non-transitory. In various implementations, non-volatile media include optical or magnetic disks, volatile media includes dynamic memory, and transmission media includes coaxial cables, copper wire, and fiber optics, including wires that comprise system bus 204. According to some embodiments, transmission media may take the form of acoustic or light waves, such as those generated during radio wave and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computing system 200. In various other embodiments of the present disclosure, a plurality of computing systems 200 coupled by a communication link 224 to network 112 (e.g., such as a LAN, WLAN, PTSN, and/or various other wired or wireless networks, including telecommunications, mobile, and cellular phone networks) may perform instruction sequences to practice the present disclosure in coordination with one another.

Computing system 200 may transmit and receive messages, data and one or more data packets, information and instructions, including one or more programs (i.e., application code) through communication link 224 and network interface component 202. Communication link 224 may be wireless through a wireless data protocol such as Wi-Fi™, 3G, 4G, HDSPA, LTE, RF, NFC, or through a wired connection. Network interface component 202 may include an antenna, either separate or integrated, to enable transmission and reception via communication link 224. Received program code may be executed by processing component 206 as received and/or stored in memory 208, 210, or 212.

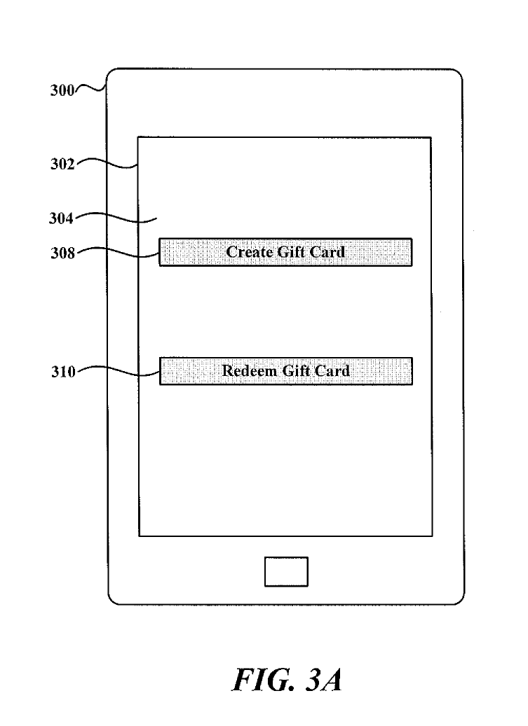

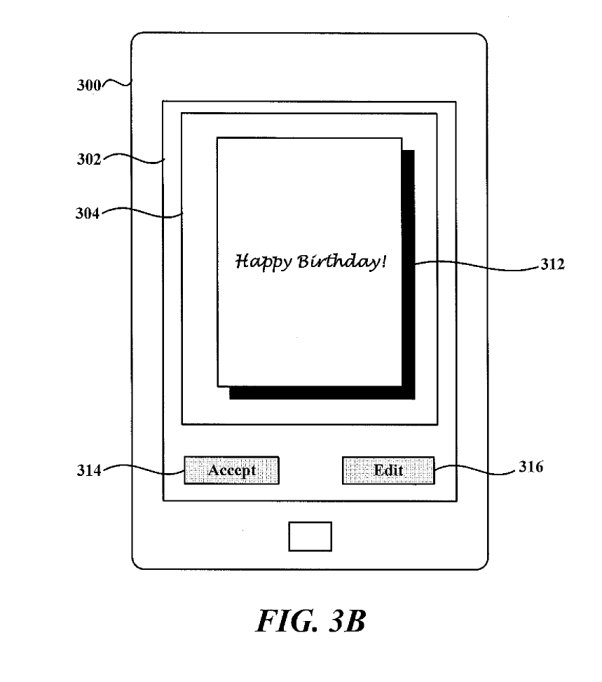

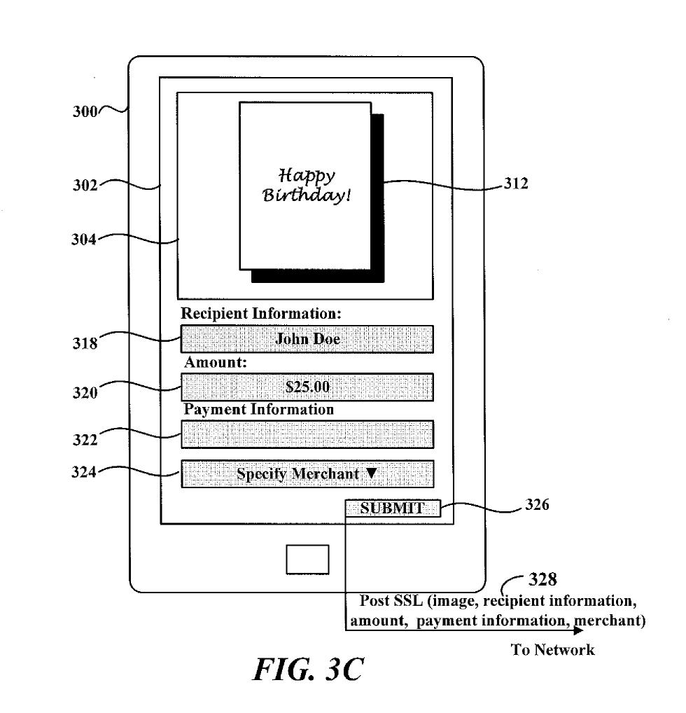

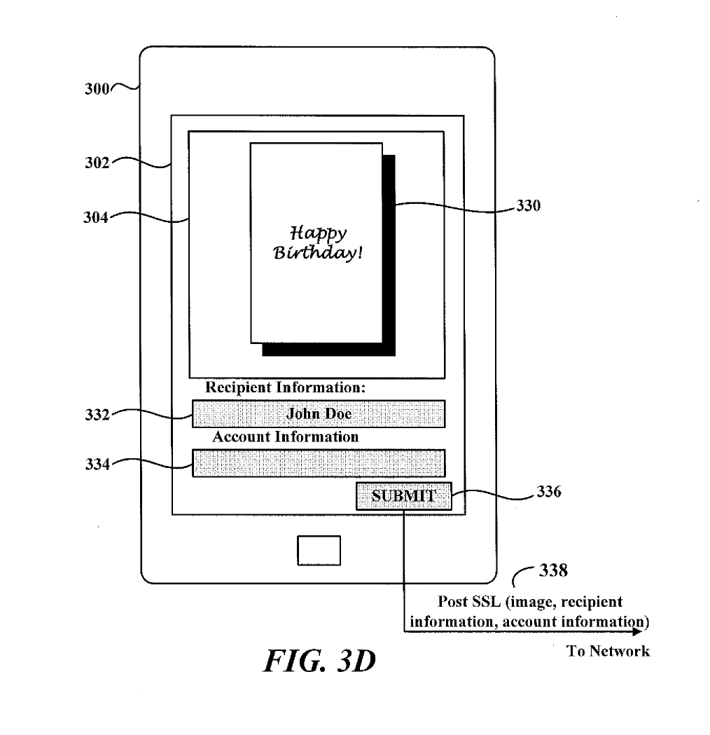

Consistent with some embodiments, sender 102 may desire to create a payment service provider-redeemable gift card based on physical object 118. Sender 102 is able to capture an image of physical object 118 using imaging functionality and applications 120 of sender device 104, associate an amount, payment information, and additional recipient information with the captured image, and transmit the captured image, payment information, and recipient information to payment service provider server 110. Physical object 118 may then be personally delivered to recipient 106 and redeemed by capturing an image of physical object 118, and transmitting the captured image along with account information and recipient information to payment service provider server 110. Payment service provider server 110 then will match the image and recipient information provided by recipient 106 to the image and recipient info nation provided by sender 102, then retrieve the amount and payment information provided by sender 102 for completing a transaction according to the account information provided by recipient 106. In one example, sender 102 wishes to make a payment service provider-redeemable gift card from a physical object 118 that is a birthday card, and give the birthday card to recipient 106. Consistent with some embodiments, sender 102 may be able to assign a monetary value to the birthday card that will be redeemable with the payment service provider. Sender 102 may be able to do this by capturing an image of the birthday card, and then sending the image along with some additional information to the payment service provider. Sender 102 may also provide written instructions on the birthday card for redeeming the birthday card with the payment service provider. Once recipient 106 receives the birthday card, recipient 106 will be able to redeem the birthday card with the payment service provider by capturing an image of the birthday card, and sending the image along with some additional information to the payment service provider. The payment service provider will then match the image received from recipient 106 with the image received from sender 102, and the redeem the monetary value associated with the birthday card using the additional information provided by both sender 102 and recipient 106. This example is shown in more detail in FIGS. 3A-3D. Although the example shown in FIGS. 3A-3D uses a birthday card as physical object 118, anything can be used as physical object 118. Moreover, even though the example describes a payment service provider-redeemable gift card, embodiments herein can be extended for any type of monetary transaction using a payment service provider by associating an image of a physical object with a monetary value, providing the physical object to a third party, and then having the third party claim the associated monetary value using an image of the provided physical object.

FIGS. 3A-3D are diagrams illustrating the creation and redemption of a payment service provider-redeemable gift card using a physical object, consistent with some embodiments. For the purposes of illustration, FIGS. 3A-3D will be described with reference to FIGS. 1 and 2. As shown in FIG. 3A, device 300 has a display 302 that may be configured to display user interface 304, consistent with some embodiments. Device 300 may correspond to sender device 104 or recipient device 108. Moreover, device 300 may also correspond to computing system 200 shown in FIG. 2. User interface 304 may be displayed on device 300 by the execution of instructions stored in a memory of device 300, such as any of memories 208, 210, or 212, by one or more processors within device 300, such as processing component 206. According to some embodiments, user interface 304 may be displayed on sender device 104 or recipient device 108 using browser 114 or 122 or a specific application 116 or 124. User interface 304 may display options for sender 102 or recipient 106, or other not shown or discussed user, for performing interactions with payment service provider server 110. Such interactions include buttons, rendered with appropriate code to be displayed on display 302 and interacted with by a user such as sender 102 or recipient 106, for selecting desired interactions. For example, user interface may include buttons for creating gift card 308 and redeeming a gift card 310. Although user interface 304 in FIG. 3A only displays two options, the number and types of options are not so limited.

Consistent with some embodiments, if sender 102 wishes to create a payment service provider-redeemable gift card using a physical object, sender will press button 308 and user interface 304 will display what is shown in FIG. 3B. As shown in FIG. 3B user interface 304 will allow sender 102 to obtain an image 312 of a physical object to create a payment service provider-redeemable gift card. In FIG. 3B, image 312 is shown as being an image of a birthday card but the embodiments disclosed herein are not so limiting. Indeed, the physical object that is used and captured as image 312 can be any object that sender 102 wishes to associate an amount to create a payment service provider-redeemable gift card. The physical object may be something as simple as a hand-written note on a piece of paper, or a colored drawing made by children, a rock, an item of clothing, or an object that requires accessories, wherein the payment service provider-redeemable gift card could be used to purchase those accessories. Image 312 may be any visual image on a physical object, such as a greeting card. Examples include a note, a greeting, an image, a photo, a design, and/or recipient and sender names. Text may be in a specific electronic style, or the sender may actually write a handwritten note and have the note scanned and used as image 312. Consistent with some embodiments, image 312 may be obtained using imaging component 222 of computing device 200, which may correspond to imaging functionality and applications 120 of sender device 104, and be stored in a memory such as memories 208, 210, or 212. Further consistent with some embodiments, image 312 may correspond to physical object 118. Although FIG. 3B only shows a single image 312, multiple images may be obtained in some embodiments. Once image 312 is obtained, user interface 304 will provide options for sender to accept 314 the obtained image or edit 316 the obtained image, by selecting an appropriately rendered button. According to some embodiments, rendered buttons 308, 310, 314, and 316, may be selected by touching the rendered button on a touch screen device, such as sender device 104. In other embodiments, the rendered buttons may be activated by navigating to the button with navigation control 218, such as a trackball, mouse, or cursor-moving device and then pressing a physical button coupled to navigation control or otherwise on sender device 104.

If sender 102 wishes to edit the obtained image, sender 102 may be allowed to recapture the image or be presented with an image editor that allows sender to perform minor edits to the image such as cropping, centering, or otherwise more clearly capture the relevant portion of the image. If sender 102 accepts the obtained image 312, user interface may display a screen such as shown in FIG. 3C. As shown in FIG. 3C, sender may be presented with form fields for associated recipient information 318 and an amount 320 to be associated with image 312. User interface 304 may also display a form field for payment information 322. Payment information may include account information corresponding to account information stored in account database 130 of payment service provider server 110. Payment information may also include a credit or debit card number, a checking account routing and account number, a voucher code, or other such means of payment. Consistent with some embodiments, sender 102 may also be presented with an option to specify a merchant 324 at which recipient will be allowed to redeem the amount 320 associated with image 312. In such embodiments, the specified merchant may offer deals to sender 102 and/or recipient 106 for redeeming the amount 320 at the specified merchant 324. Such deals may include offering sender 102 a percentage of amount 320 once recipient 106 redeems the amount 320 with the merchant 324. Although not shown in FIG. 3C, sender 102 may also be presented with a form field allowing sender to specify a date indicating when the gift card expires or a time period for which the gift card will be valid.

Returning to FIG. 3C, sender 102 may add recipient information 318 to be associated with image 312. Consistent with some embodiments, recipient information 318 may be a name, username, phone number, or other unique identifier of recipient 106. In particular, recipient information 318 may be associated with image 312 to assist in identifying the correct amount, merchant and payment information associated with image 312 for later redemption by recipient 106. Recipient information 318 needs to be specific enough to identify the correct amount, merchant and payment information associated with image 312 without being too specific such that recipient 106 encounters difficulties in later redeeming. For example, e-mail addresses may not provide reliable as recipient information 318 because recipient 106 may have multiple e-mail addresses, and may not know exactly which e-mail address sender 102 used as recipient information 318. Once sender 102 is satisfied with the information entered into user interface 304, sender 102 may select the rendered submit button 326. Upon selecting submit 326, the captured image (or images), which may pixel data or other data representative of the captured image, recipient information, amount, payment information, and merchant if selected will be bundled into one or more data packets 328 that will be posted to payment service provider server 110 through network 112. Consistent with some embodiments, a digital representation of the captured image may be transmitted instead of the captured image. Such a digital representation may include a fingerprint or hash of the pixel data of the captured image. Other digital representations may include metadata about the captured image such as the file name and file size of the captured image, the date on which the image was captured and, if device 300 includes a location component such as location component 220, a geographical location indicating where the image was captured obtained using GPS technology. Further, the metadata may also be transmitted to payment service provide server 110 along with the captured image as part of the one or more data packets 328. The information in the one or more data packets 328 will be stored in image database 128 of payment service provider server 110. In some embodiments, payment service provider server 110 may transmit an acknowledgement to sender 102 and sender device 104 upon receiving the one or more data packets 328.

According to some embodiments, the one or more data packets 328 may be securely posted over network 112 using known secure techniques, such as a secure socket layer (SSL) connection. Although not shown in FIG. 3C, sender 102 may specify a time limit in which the recipient needs to redeem the payment service provider-redeemable gift card, which could also be included in the one or more data packets 328. However, the time limit may be governed by local consumer laws governing gift cards, if applicable.

After sender 102 has created the a payment service provider-redeemable gift card using a physical object 118, sender 102 can now deliver physical object 118 in person to recipient 106. Once recipient 106 has received physical object 118, it can be redeemed using recipient device 108, much in the same way that the payment service provider-redeemable gift card was created. Referring back to FIG. 3A, recipient 106 will select the Redeem Gift Card button 310 and be presented with user interface 304 shown in FIG. 3B for obtaining an image of physical object 118. Just as before with sender 102, recipient 106 will have the opportunity to edit the obtained image or accept the obtained image. After recipient 106 has accepted the obtained image, a user interface 304 such as shown in FIG. 3D will be presented to recipient. As shown in FIG. 3D, user interface 304 displays an image 330 of the received physical object 118 and a form field for recipient information 332. User interface 304 may display a form field allowing recipient to enter account information 334 to complete the transaction of redeeming the gift card, which may include information relating to a banking, credit card, or other account into which the amount associated with the physical object can be deposited. Once recipient 106 has entered the associated recipient information into field 330, and account information into form field 334, recipient 106 may then select the submit button 336. Image 330, recipient information 332, and account information 334 may then be bundled into one or more data packets 338 that may be transmitted to payment service provider server 110.

Consistent with some embodiments, once payment service provider server 110 receives the one or more data packets 338, payment service provider server 110 will match image 330 and recipient information 332 to image 312, recipient information 318, amount 320 and merchant 324 (if selected) included in one or more data packets 328 that was stored in image database 128. Initially, payment service provider server 110 may narrow the field in which to match by doing a first match by recipient information. Once the field of images has been limited by recipient information, payment service provider server 110 will match image 330 to image 312 to retrieve the associated amount 320 and merchant 324 (if selected), as well as associated payment information 322. Consistent with some embodiments, payment service provider server 110 may use color analysis and edge detection algorithms to match image 330 to image 312. Once a match has been obtained, payment service provider server 110 may complete the transaction by transferring the amount from the sender's account to the recipient's account by debiting the amount from sender's account according to payment information 322 and depositing the amount in recipient's account according to account information 334. Consistent with some embodiments, if sender 102 and recipient 106 both have an account with the payment service provider, payment service provider server 110 may use account database 130 and/or account information 132 to complete the transaction of redeeming the gift card. However, if sender 102 and/or receiver have specified additional information for completing the transaction, such as credit card or banking account information, payment service provider server 110 will use this provided information to complete the transaction. When completing the transaction, any transaction fees imposed by the payment service provider may be levied and debited appropriately from, for example, according to payment information 322 provided by sender 102.

Consistent with some embodiments, a digital representation may be created of the redeemed payment service provider-redeemable gift card and stored in a digital wallet on recipient device 106. The digital representation may include the captured image 330 and a redemption code provided by payment service provider server 110. The digital wallet may be an application that stores gift cards, movie tickets and the like, such as Passbook provided by the iOS™ operating system, or other similar digital wallet solutions provided by or operating on the Android™ operating system, BlackBerry™ operating system, Microsoft® Windows® Phone operating system, or webOS™.

Consistent with some embodiments, after redemption by recipient, payment service provider server 110 may delete image 312, recipient information 318, amount 320, payment information 322, and merchant 324 (if specified) from image dataset 128. Deleting this stored information after redemption ensures that another person is not able to obtain money from sender 102 by using an image of physical object 118 for redemption.

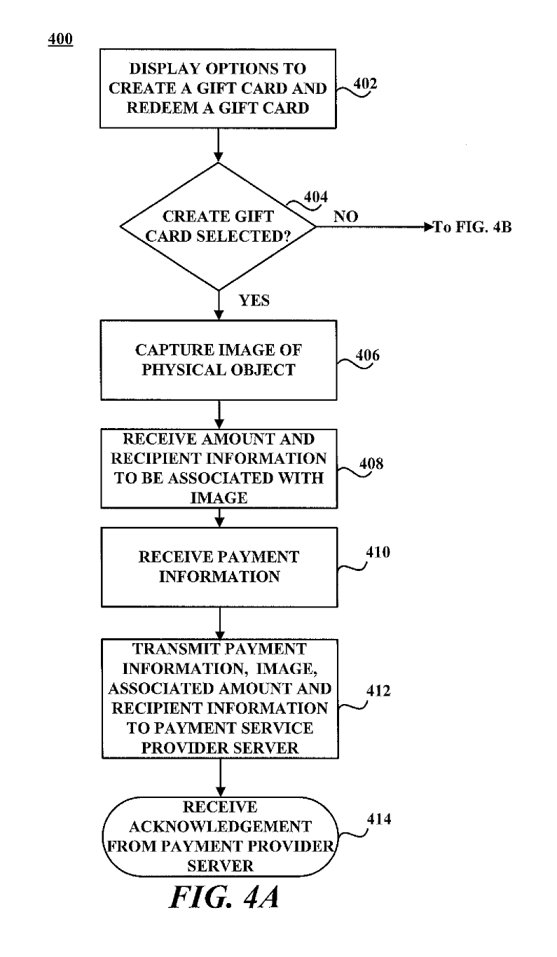

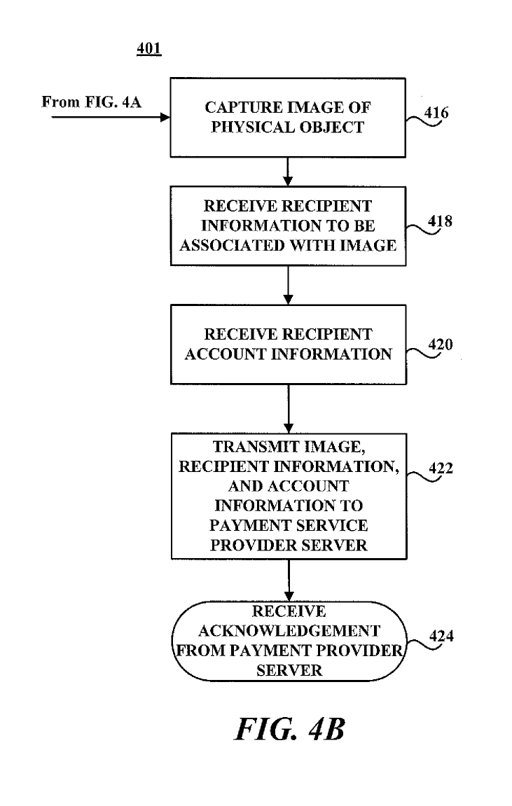

FIGS. 4A and 4B are flowcharts illustrating methods 400 and 401 for the creation and redemption of a payment service provider-redeemable gift card using a physical object on a computing device, consistent with some embodiments. For the purpose of illustration, FIGS. 4A and 4B will be described with reference to FIGS. 1, 2, and 3A-3D. Consistent with some embodiments, method 400 may be embodied in computer-readable instructions for execution by one or more processors in sender device 104 such that sender device 104 performs the steps of method 400. The method 400 begins by displaying options to create or redeem a gift card (402). Consistent with some embodiments, the displayed options may be displayed by a user interface 304 on a display 302 of device 300 as shown in FIG. 3A. Moreover, the options may be displayed on sender device 104 or recipient device 106, both of which may correspond to computing system 200. Furthermore, the methods shown in FIGS. 4A and 4B may be embodied in computer-readable instructions stored in any of memories 208, 210, and 212 and executed by one or more processors 206. Returning to FIG. 4A, the method 400 will determine if create gift card button 308 has been selected (404). If create gift card button 308 has not been selected, the method will assume that the redeem gift card button 310 has been selected and begin executing the gift card redemption method 401, which is discussed in FIG. 4B. If the create gift card button 308 has been selected, the method 400 will proceed to capture an image of the physical object that will be associated with the payment service provide-redeemable gift card (406). As described with respect to FIG. 3B, image 312 may be obtained using imaging component 222 of computing device 200, which may correspond to imaging functionality and applications 120 of sender device 104, and be stored in a memory such as memories 208, 210, or 212. After image 312 has been accepted by sender 102, the method 400 will request and receive from sender 102 an amount and recipient information to be associated with image 312 (408). As described with respect to FIG. 3C, recipient information may be entered in form field 318 and the amount may be entered in form field 320. Recipient information may be associated with image 312 to assist in identifying redemption information associated with image 312, such as an amount, sender payment information, and a specified merchant for redemption by recipient 106.

Returning to FIG. 4A, the method 400 then receives payment information 322 (410). If sender 102 has an account with the payment service provider, sender 102 may enter their account information which would match account information 132 stored in payment service provider server 110. This information could then be used to set up a payment for the amount associated with image 312. However, if sender 102 does not have an account with the payment service provider, the payment information may include a credit card number, banking or other financial account information, or a voucher. Next, method 400 transmits the payment information, image 312, the associated amount and recipient information to payment service provider server 110 (412). As described with respect to FIG. 3C, this information may be bundled into one or more data packets 328 and may be securely transmitted. After the transmitted information is received and stored by payment service provider server 110, payment service provider server 110 may transmit an acknowledgement message that will be received by sender device 102 (414). Consistent with some embodiments, the acknowledgement message may include the details of the information transmitted to and stored by payment service provider server 110, such as the payment information, the recipient information, the image, and the merchant (if specified), allowing sender 102 to review the transaction. The acknowledgement message may also include a unique transaction code and may be sent by e-mail, short messaging service (SMS) or multimedia messaging service (MMS).

FIG. 4B is a flowchart illustrating a method 401 for redeeming a payment service provider-redeemable gift card based on a physical object, consistent with some embodiments. Consistent with some embodiments, method 401 may be embodied in computer-readable instructions for execution by one or more processors on recipient device 108 such that recipient device 108 performs the steps of method 401. As described in FIG. 4A, if method 400 determines that create a gift card has not been selected, method 401 will be executed for redeeming a gift card. The redemption of a payment service provider-redeemable gift card based on a physical object first requires recipient 106 to capture an image 330 of the physical object (416). As described with respect to FIG. 3B, image 330 may be obtained using imaging component 222 of computing device 200, which may correspond to imaging functionality and applications 126 of recipient device 108, and be stored in a memory such as memories 208, 210, or 212. After image 330 has been accepted by sender 102, the method 401 will request and receive from recipient 106 recipient information (418). Method 401 will then request and receive recipient account information (420). If recipient 106 has an account with the payment service provider, recipient 106 may enter their account information which would match account information 132 stored in payment service provider server 110. However, if recipient 106 does not have an account with the payment service provider, the payment information may include a credit card number, banking or other financial account information, or a voucher. Alternatively, recipient 106 may be prompted to create an account with the payment service provider. After the method 401 has received the image, the recipient information, and the account information, all of this information is transmitted to payment service provider server 110 (422). As described with respect to FIG. 3D, this information may be bundled into one or more data packets 338 and may be securely transmitted. After the transmitted information is received and stored by payment service provider server 110, payment service provider server 110 will transmit an acknowledgement message that will be received by recipient device 108 (424). Consistent with some embodiments, the acknowledgement message may include the details of the information transmitted to and stored by payment service provider server 110, such as the account information, the recipient information, and the image, and the merchant, allowing recipient 106 to review the transaction. The acknowledgement message may be sent by e-mail, short messaging service (SMS) or multimedia messaging service (MMS).

Although not shown in FIG. 4B, consistent with some embodiments, a digital representation may be created of the redeemed payment service provider-redeemable gift card and stored in a digital wallet on recipient device 106. The digital representation may include the captured image 330 and a redemption code provided by payment service provider server 110. The digital wallet may be an application that stores gift cards, movie tickets and the like, such as Passbook provided by the iOS™ operating system, or other similar digital wallet solutions provided by or operating on the Android™ operating system, BlackBerry™ operating system, Microsoft® Windows® Phone operating system, or webOS™.

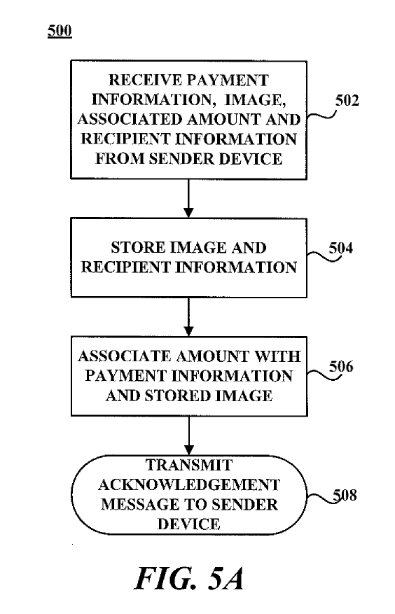

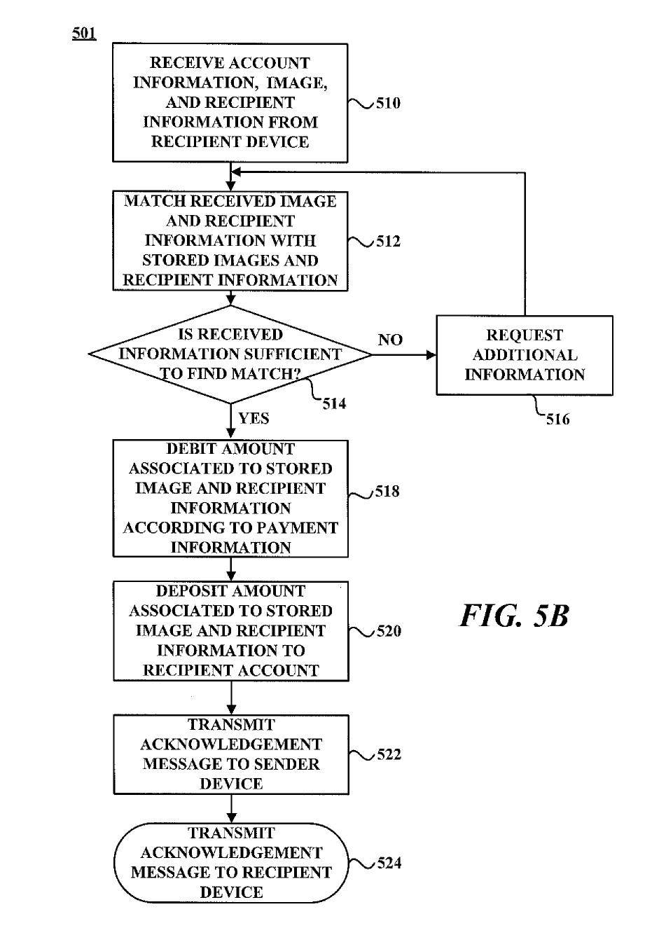

FIGS. 5A and 5B are flowcharts illustrating methods 500 and 501 for the creation and redemption of a payment service provider-redeemable gift card using a physical object on a payment service provider server, consistent with some embodiments. For the purpose of illustration, FIGS. 5A and 5B will be described with reference to FIGS. 1, 2, and 3A-3D. Methods 500 and 501 may be embodied as in computer-readable instructions for execution by one or more processors on payment service provider server 110 such that the steps of methods 500 and 501 are performed by payment service provider server 110. Method 500 in FIG. 5A may correspond to the method undertaken by payment service provider server 110 for the creation of a payment service provider-redeemable gift card using a physical object and method 501 in FIG. 5B may correspond to the method undertaken by payment service provider server 110 for the redemption of a payment service provider-redeemable gift card using a physical object, consistent with some embodiments.

As shown in FIG. 5A, method 500 begins by receiving payment information, an image, an associated amount, and recipient information from sender device 104 (502). Consistent with some embodiments, the received information may be received in one or more data packets 328 and may be received over a secure connection. The received image and recipient information is then stored in image database 128 of payment service provider server 110 (504). Method 500 then associates the received amount with the payment information and the stored image (506). Consistent with some embodiments, the associated amount and payment information may also be stored in payment service provider server 110. The method 500 then transmits an acknowledgment message to sender device 104 (508). Consistent with some embodiments, the acknowledgement message may include the details of the information transmitted to and stored by payment service provider server 110, such as the payment information, the recipient information, the image, and the merchant (if specified), allowing sender 102 to review the transaction. The acknowledgement message may be sent by e-mail, short messaging service (SMS) or multimedia messaging service (MMS).

As shown in FIG. 5B, method 501 begins by receiving account information, an image, and recipient information from recipient device 108 (510). Consistent with some embodiments, the received information may be received as one or more data packets 338 that are transmitted over a secure connection. Based on the received image and recipient information, payment service provider server 110 will attempt to match the received image and recipient information to the stored image and recipient information received from sender device 104 (512). Consistent with some embodiments, payment service provider server 110 may first attempt to filter the search of image database 128 by searching for all stored images that match the recipient information. Payment service provider server 110 may then search all of the matching entries for a matching image using image matching algorithms. Such image matching algorithms may include color analysis algorithms, edge detection algorithms, image overlap algorithms, and feature detection and comparison algorithms. If the received image and recipient information is insufficient to find a match (514), payment service provider server 110 will request additional information (516) from recipient 106. Such additional information may include a transaction code that was provided to sender 102, or the name or other information about sender 102. Once a matching image has been found, payment service provider server 110 may then look up the amount and payment information that was associated with the image and recipient information and debit the amount according to the payment information (518). That same amount may then be deposited to an account specified by recipient 106 (520). Payment service provider server 110 may then send an acknowledgement to sender 102 and/or sender device 104 (522) and an acknowledgment to recipient 106 and/or recipient device 108 (524). The acknowledgment messages may allow sender 102 and recipient 106 that the transaction has been completed, and provide sender 102 and recipient 106 with the opportunity to contact payment service provider server 110 if any errors have been made.

Although not shown in FIG. 5B, after redemption by recipient, payment service provider server 110 may delete image 312, recipient information 318, amount 320, payment information 322, and merchant 324 (if specified) from image database 128. Deleting this stored information after redemption ensures that another person is not able to obtain money from sender 102 by using an image of physical object 118 for redemption.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Consequently, embodiments as described herein may provide devices, systems and methods for facilitating payment service provider transactions using physical objects. In particular, devices, systems, and methods disclosed herein may be used to create a payment service provider-redeemable gift card using a physical object. The examples provided above are exemplary only and are not intended to be limiting. One skilled in the art may readily devise other systems consistent with the disclosed embodiments which are intended to be within the scope of this disclosure. As such, the application is limited only by the following claims.

1. A device for processing a transaction between a sender and a recipient using a physical object, comprising:
a network interface component coupled to a network and configured to receive a first one or more data packets comprising first captured image data of the physical object and an amount to be associated with the first captured image data from the sender;
a memory coupled to the network interface component and configured to store the first captured image data and the amount; and
one or more processors coupled to the memory and the network interface component, the one or more processors configured to:
match second captured image data of the physical object included in a second one or more data packets received by the network interface component from the recipient to the first captured image data of the physical object using image matching algorithms, the physical object having been physically transferred from the sender to the recipient;
determine the amount associated with the first captured image data if the second captured image data matches the first captured image data; and
transfer the associated amount from an account specified by the sender to an account specified by the recipient.

2. (canceled)

3. The device of claim 1, wherein the first one or more data packets further comprise at least one of recipient information, payment information, and a specified merchant.

4. The device of claim 3, wherein the second one or more data packets further comprise at least one of the recipient information and account information.

5. The device of claim 4, wherein the one or more processors are further configured to match the second captured image data to the first captured image data using the recipient information.

6. The device of claim 1, wherein the one or more processors are further configured to delete the first captured image data and the amount after the associated amount has been transferred to the account specified by the recipient.

7. The device of claim 1, wherein the one or more processors are further configured to generate an acknowledgement message to be transmitted by the network interface component to the sender and the recipient after the associated amount has been transferred to the account specified by the recipient.

8. A method for processing a transaction between a sender and a recipient using a physical object, comprising:
receiving, by a network interface component of a processing device, a first captured image of the physical object and an amount to be associated with the physical object;
storing, in a memory of the processing device, the first captured image and the amount;
receiving, by the network interface component, a second captured image of the physical object;
matching, using one or more processors of the processing device, the second captured image to the first captured image;
determining, by the one or more processors, the amount associated with the first captured image if the second captured image matches the first captured image;
transferring, by the one or more processors, the associated amount from an account specified by the sender to an account specified by the recipient.

9. The method of claim 8, wherein receiving the first captured image further comprises receiving recipient information and payment information along with the first captured image and the associated amount.

10. The method of claim 9, wherein receiving the second captured image further comprises receiving recipient information and account information along with the second captured image.

11. The method of claim 10, wherein matching the second captured image to the first captured image comprises:
filtering images stored in the memory by the recipient information; and
matching the filtered images using image matching algorithms.

12. The method of claim 8, further comprising:
requesting additional information if the second image does not match the first image.

13. The method of claim 12, wherein the additional information comprises a transaction code generated by the one or more processors and transmitted to the sender after the first captured image has been received.

14. The method of claim 8, further comprising:
generating, by the one or more processors, acknowledgement messages for the sender and the recipient after the associated amount has been transferred to the account specified by the recipient; and
transmitting, by the network interface component, the acknowledgement messages to the sender and the recipient.

15. The method of claim 8, further comprising:
deleting the first captured image and the amount after the associated amount has been transferred to the account specified by the recipient.

16-20. (canceled)

21. A non-transitory computer-readable medium having instructions for execution by one or more processors that, when executed, cause the one or more processors to perform a method processing a transaction between a sender and a recipient using a physical object, the method comprising:
receiving a first captured image of the physical object and an amount to be associated with the physical object;
storing the first captured image and the amount;
receiving a second captured image of the physical object;
matching the second captured image to the first captured image;
determining the amount associated with the first captured image if the second captured image matches the first captured image;
transferring the associated amount from an account specified by the sender to an account specified by the recipient.

22. The computer-readable medium of claim 21, wherein receiving the first captured image further comprises receiving recipient information and payment information along with the first captured image and the associated amount.

23. The computer-readable medium of claim 22, wherein receiving the second captured image further comprises receiving recipient information and account information along with the second captured image.

24. The computer-readable medium of claim 23, wherein matching the second captured image to the first captured image comprises:
filtering images stored in the memory by the recipient information; and
matching the filtered images using image matching algorithms.

25. The computer-readable medium of claim 21, the method further comprising:
requesting additional information if the second image does not match the first image.

26. The computer-readable medium of claim 25, wherein the additional information comprises a transaction code generated by the one or more processors and transmitted to the sender after the first captured image has been received.
